(19) United States
(12) Patent Application Publication
(10) Pub. No.: US 2009/0036563 A1
(43) Pub. Date: Feb. 5, 2009

(54) POLYMER BLEND FOR PRODUCING SHAPE-MEMORY FOAM, FOAM THEREOF AND METHOD FOR PRODUCING THE FOAM

(75) Inventors: Chia-Hon Tai, Tainan City (TW); Hong-Fan Lin, Changhua County (TW); Fu-Yu Tsai, Tainan County (TW); Yu-Hsin Tsai, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 11/864,929

(22) Filed: Sep. 29, 2007

(30) Foreign Application Priority Data
Aug. 3, 2007 (TW) 96128698

(51) Int. Cl. C08G 63/16; C08G 18/00

(52) U.S. Cl. 521/182; 525/444; 525/440.01

(57) ABSTRACT

A shape-memory polymer foam is disclosed, which is formed by kneading a shape-memory copolyester with a polymeric material having a relatively lower crystallinity in a weight ratio of 15:85 to 85:15 and then conducting a foaming process. The shape-memory copolyester is a random copolymer formed from a dicarboxylic acid mixture and a diol in excess through esterfication and polycondensation. The dicarboxylic acid mixture includes 30-99 mol % of an aromatic dicarboxylic acid and 70-1 mol % of a straight aliphatic dicarboxylic acid of C₄-C₁₀. The diol includes a straight aliphatic diol of C₂-C₁₀.

### CROSS-REFERENCE TO RELATED APPLICATION

This application claims the priority benefit of Taiwan application serial No. 96128698, filed Aug. 3, 2007. All disclosure of the Taiwan application is incorporated herein by reference.

### BACKGROUND OF THE INVENTION

1. Field of the Invention

This invention relates to a polymer blend for producing a shape-memory foam, a foam thereof and a method for producing the foam.

2. Description of the Related Art

Polymeric foams, such as foamed polystyrene, polyurethane or polyester, have been widely used in certain fields like heat insulation material and packing material as being good at heat insulation and impact absorption, etc. However, traditional foamed materials are limited in their processing due to the elasticity control issue, so that the performances of the products therefrom are lower.

Hence, the shape-memory foam is provided, which can be compressed or rolled up with an external force at a temperature above the glass transition temperature (T_{g}) thereof, maintain the deformed shape as the temperature is down and recover its original shape with heating without external force. The shape-memory foam can be controlled in the elasticity through adjustments in the temperature and external force, thus having high-temperature plasticity. There have been many shape-memory foams proposed, which can be classified to three categories, including those formed from shape-memory polyurethane with a foaming process, those from a non-shape-memory material with a foaming process causing a microstructure with shape-memory property, and composite shape-memory materials obtained by adding a thermoplastic elastomer into a plastic foam.

U.S. Pat. No. 5,049,591 discloses a composition of a shape-memory polyurethane foam and production thereof, teaching that the shape-memory foam having been being compressed at a temperature above the T_{g} thereof can keep the deformed shape as the temperature is down and can recover its original shape without an external force after being heated again to a temperature above the T_{g}. In addition, the material of this patent is formed from a diisocyanate monomer (R(NCO)₂), a difunctional polyol (R′(OH)₂) and a chain extender (R″(OH)₂) and is expressed by the following formula: HOR″QCONH(RNHCOOR′OCONH)ₙRNHCOOR″OCONH(RNHCOOROCONH)ₘRNHCOOR″OH It is also taught that the crystallinity and T_{g} of the material can be adjusted by adjusting the structures of the difunctional polyol and the chain extender and their ratio, and the foam can be produced by adding a foaming agent and conducting extrusion foaming.

U.S. Pat. No. 6,583,194 also discloses a composition of a shape-memory polyurethane foam and production thereof, different from U.S. Pat. No. 5,049,591 in the chemical structure of the polymer. The diisocyanate used is mainly an oligomer, while the diol used is an aromatic polyester polyol with a functionality of 2-2.3, polycarbonate polyol, polyether polyol or a combination thereof. The ratio of diisocyanate to diol is 0.9:1, and the T_{g} of the polymer synthesized is higher than 35° C.

U.S. Pat. No. 5,418,261 also discloses a composition of a shape-memory polyurethane foam and production thereof, different from both U.S. Pat. No. 5,049,591 and U.S. Pat. No. 6,583,194 in the chemical structure of the polymer. The foam is formed by polymerizing an oligomer containing at least 85% of diphenylmethane diisocyanate and a polyoxy-alkylene polyol having an average hydroxyl number of 2.2-6 and an average equivalent of 250-1500 in the presence of water as a foaming agent without catalysis of a catalyst.

European Patent No. 1 184 149 discloses a method of forming a shape-memory foam though polymer kneading and a composition of the same. An elastic base foam is prepared, and then an impregnated material as a thermoplastic polymer with a lower T_{g} or melting temperature (Tₘ) is uniformly blended in the base foam to produce a shape-memory foam. The shape-memory behavior of the foam is similar to the above-mentioned. Specifically, the foam having been deformed at a temperature higher than the T_{g} or Tₘ of the impregnated polymer hardens after the temperature is lowered to keep the deformed shape, and recovers its original shape after being heated to a high temperature.

U.S. Pat. No. 6,817,441 discloses a composition and a producing method of a shape-memory foam and the application thereof as a sound insulator of mobile engines. The shape-memory behavior of the foam is similar to the above-mentioned. The foam is applied outside an engine after being compressed under heating, and will recover its original shape due to the heat generated by the engine to cover the engine and reduce the noise. The foam of this patent is formed from a foamable traditional material with a foaming process that gives a shape-memory property to the material.

U.S. Pat. No. 6,090,479 discloses a composition and a producing method of a shape-memory foam that can recover its shape without heating. If the foamed material is deformed by a force at a temperature below the T_{g} or Tₘ that is above 0° C. and usually room temperature, it keeps the deformed shape after the temperature is lowered below 0° C. and will recover its original shape after a period of time at the room temperature. With respect to the structure, the material is constituted of a base foam and an outer gas-penetrating layer that allows air to flow in the compressed foam and recover the shape of the same. Except the inclusion of the gas-penetrating layer, it is also required to use a polymeric material with a flexural modulus of 100-20000 kgf/cm², a T_{g} lower than 0° C. and a crosslinking degree smaller than 40% (when the polymeric material is a crosslinked one) or a ratio of closed foam cells to total foam cells larger than 30% to achieve a shape-memory property.

The polyester foam not only can effectively reduce the weight of the polyester material to reduce the cost, but also has good thermal resistance, chemical resistance and recyclability. Hence, there is a large market for the polyester foam in the fields of food packing, microwave container, heat insulation inside refrigerators or at roofs, wire insulation, microelectronic circuit board insulation, athletic equipment, and mobile and aerospace industry.

However, the polyester foam is a rigid material due to its high crystallinity, and is therefore more difficult to process than soft foamed materials. Hence, the polyester foam is difficult to adjust in the shape in the cases of packing/heat insulation, and is therefore limited in its applications.

On the other hand, shape-memory copolyester has also been disclosed, mainly including shape-memory polyethylene terephthalate-polyetherketone copolymer and shape-memory poly(ethylene terephthalate-succinate) copolymer, etc. However, no foamed product therefrom has been disclosed in the prior art.

### SUMMARY OF THE INVENTION

This invention provides a shape-memory foam that can be changed arbitrarily in the shape and thus has increased applicability and value.

This invention also provides a shape-memory foam that can be adjusted in the rigidity, shape-memory trigger temperature and recovery ratio.

This invention further provides a method of producing a shape-memory foam, which includes a simple process.

This invention further provides a polymer blend for producing a shape-memory foam, which can be converted to the latter through an ordinary foaming process.

The shape-memory foam of this invention is produced by kneading a shape- memory copolyester with a polymeric material in a weight ratio of 15:85 to 85:15 and then conducting a foaming process. The copolyester has a crystallinity higher than that of the polymeric material and is a random copolymer formed from a dicarboxylic acid mixture and a diol in excess through esterfication and polycondensation. The dicarboxylic acid mixture includes 30-99 mol % of an aromatic dicarboxylic acid and 70-1 mol % of a straight aliphatic dicarboxylic acid of C₄-C₁₀. The diol includes a straight aliphatic diol of C₂-C₁₀.

The polymer blend for forming a shape-memory foam of this invention includes a shape-memory copolyester and a polymeric material both as defined above in a weight ratio of 15:85 to 85:15.

The method for producing a shape-memory foam of this invention includes kneading a shape-memory copolyester with a polymeric material both as defined above in a weight ratio of 15:85 to 85:15 and then conducting a foaming process.

The shape-memory foam of this invention can be changed arbitrarily in the shape, and thus has increased applicability and value.

Moreover, the rigidity, shape-memory trigger temperature and recovery ratio of the shape-memory foam of this invention is easy to adjust.

Moreover, the method of producing a shape-memory foam of this invention includes a simple process.

Furthermore, the polymer blend of this invention can be easily converted to a shape-memory foam of this invention through an ordinary foaming process.

It is to be understood that both the foregoing general description and the following detailed description are exemplary, and are intended to provide further explanation of the invention as claimed.

### DESCRIPTION OF THE PREFERRED EMBODIMENTS

The shape-memory foam of this invention is formed by kneading a shape-memory copolyester with a high crystallinity and a polymer with a relatively lower crystallinity or zero crystallinity in a weight ratio of 15:85 to 85:15 and then subjecting the blend to a foaming process.

The above high-crystallinity shape-memory copolyester is a random copolymer formed from a dicarboxylic acid mixture and a diol in excess through an esterfication reaction and a polycondensation reaction. It is preferred that the copolyester has a viscosity [η] of 0.3-0.8 dL/g, a crystallinity of 80-90, a T_{g} of 30-100° C., a melting temperature (Tₘ) of 170-250° C. and a shape-memory trigger temperature of 30-70° C.

The above dicarboxylic acid mixture includes an aromatic dicarboxylic acid and a straight aliphatic dicarboxylic acid. Examples of the aromatic dicarboxylic acid include terephthalic acid, phthalic acid, isophthalic acid, tetrahydrophthalic acid, naphthalene dicarboxylic acid, diphenylether dicarboxylic acid, biphenyl dicarboxylic acid, diphenylsulfone dicarboxylic acid and diphenoxyethane dicarboxylic acid, etc. The straight aliphatic dicarboxylic acid has a carbon number of 4-10, and examples thereof include succinic acid, glutaric acid, adipic acid, pimelic acid, suberic acid, azelaic acid, sebacic acid, maleic acid, methyl-maleic acid, fumaric acid, methyl-fumaric acid and so on.

The above diol includes a straight aliphatic diol of C₂-C₁₀ that is a primary diol, a secondary diol or a primary/secondary diol. Examples of the same include ethylene glycol, propylene glycol, butanediol, pentanediol, hexanediol, heptanediol, octanediol, nonanediol, decanediol, methyl propylene glycol, 1,6-hexanediol, 1,3-butanediol, 2-ethyl-1,4-butanediol, 1,5-pentanediol, 2-methyl-1,4-butanediol and so on.

In some embodiments, the shape-memory copolyester is a random copolymer formed from terephthalic acid, succinic acid, ethylene glycol and 1,4-butanediol through esterfication and polycondensation, as shown below.

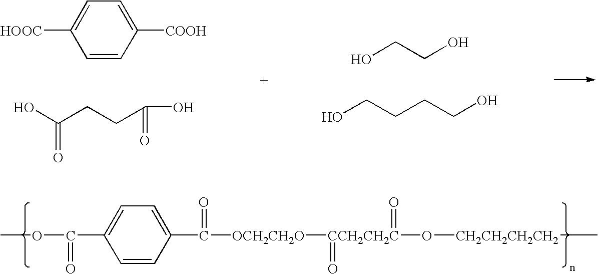

The inclusion of a long-chain aliphatic unit makes the copolyester more difficult to crystallize, thus lowering the crystallization temperature of the same. Therefore, increasing the percentage of aliphatic units effectively lowers the trigger temperature, from about 100° C. to 30-70° C. In other words, the crystallization temperature of the copolyester of this invention can be adjusted by changing the percentage or the carbon number of the aliphatic species in the dicarboxylic acid and diol used, so as to alter the trigger temperature. Specifically, when the trigger temperature is to be lowered, it is feasible to increase the percentage of the straight aliphatic dicarboxylic acid, or to use a straight aliphatic dicarboxylic acid having a larger carbon number or a straight aliphatic diol having a larger carbon number. When the trigger temperature is to be raised, it is feasible to decrease the percentage of the straight aliphatic dicarboxylic acid or to use a straight aliphatic dicarboxylic acid having a smaller carbon number or a straight aliphatic diol having a smaller carbon number.

In producing the above shape-memory copolyester, the equivalent ratio of the dicarboxylic acid to the diol may be 1:1.2. In an embodiment, terephthalic acid takes 30-99 mol % of the dicarboxylic acid mixture used while the other takes 70-1 mol %, and ethylene glycol takes 1-100 mol % of the diol used while the other takes 99-0 mol %.

The esterfication reaction may be conducted at a temperature of 240-260° C. for 1.5-3 hours. In practice, the reaction endpoint can be determined as a point when no more wafer is produced. After the esterfication is completed, the polycondensation reaction is conducted at a temperature of 270-290° C. for 4-6 hours. In practice, the reaction time is determined according to the molecular weight required, and a catalyst like antimony acetate and cobalt acetate can be used in the polycondensation reaction.

The polymeric material with a relatively lower crystallinity or zero crystallinity may be a polymer or a polymer blend with a crystallinity of 0-30. By kneading such a polymeric material with the shape-memory copolyester, the trigger temperature and its viscoelastic property can be further adjusted. The polymeric material may be selected from the group consisting of glycol-modified polyethylene terephthalate (PETG), polylactate (PLA), polycaprolactone (PCL), polyurethane (PU), polyetherester, polyvalerolactone, polyhydroxyalkanoate (PHA), straight aliphatic copolyester like polybutylenesuccinate (PBS), and combinations thereof.

The method for kneading the above shape-memory copolyester with the above polymeric material may include kneading the same in a kneader for a period of time and then rapidly cooling the blend. The kneader may be a twin-screw kneader, and the period of the kneading may be 3-5 minutes. After the kneading, the temperature is rapidly lowered to about 25-35° C. to prevent recrystallization.

The method of foaming the kneaded blend may be based on physical foaming or chemical foaming. In an embodiment, a physical foaming process like a pressure induced phase separation (PIPS) foaming process is adopted.

A PIPS foaming process includes three steps, impregnation of a foaming agent in a supercritical state, mold strength control, and pore formation through the phase transition of the foaming agent. In the impregnation step, the kneaded blend is loaded in a closed container sustaining high temperature and high pressure, and a supercritical physical foaming agent, usually CO₂ or N₂, is injected to stay with the blend. Due to the high density and high permeability of supercritical fluid, the foaming agent rapidly diffuses into the kneaded blend in a large amount, and the blend will be saturated with the foaming agent to have a homogeneous phase after a certain period of time.

After the homogeneous phase is made, a mold strength control step is conducted to adjust the temperature and the pressure and thereby control the viscoelasticity of the material within a proper range that allows the later phase transition of the foaming agent in the material to produce pores and form a porous structure having a sufficient strength.

After the impregnation and mold strength control steps, a pore formation step including a phase transition of the foaming agent is conducted. The pressure is rapidly reduced to change the phase of the foaming agent in the material to a gas phase from the supercritical phase and thereby form a porous structure in the material. Meanwhile, because the foaming agent undergoes an adiabatic expansion in the phase transition due to the rapid pressure reduction, the walls of the pores formed in the material is cooled rapidly so that a foamed material with a solid porous structure is obtained.

The condition of the foaming molding can be modified according to the melting temperature of the kneaded blend. In the impregnation step, the temperature can be controlled within the range of 145-170° C. and the pressure within the range of 1200-4500 psi. Generally, the temperature set in the impregnation step is correlated with the percentage of the shape-memory copolyester in the kneaded blend. As the percentage of the copolyester is larger, the temperature and pressure in the impregnation step are set higher, and the foaming ratio is higher. The foaming ratio may range from 1.5 to 15.

Though the foaming process in this invention is exemplified by an environment- friendly physical-type supercritical foaming process as above, this invention is not limited to use such a foaming process. An ordinary physical foaming process is also workable, wherein the physical foaming agent can be an organic foaming agent or an inorganic gaseous foaming agent. Examples of the organic foaming agent are aliphatic hydrocarbons and halogenated hydrocarbons, etc., wherein examples of the former include propane, butane, hexane, cyclobutane, cyclohexane and so on, and examples of the latter include hydrocarbons substituted by chlorine and/or fluorine, of which the examples include 1,1,2-trichloro-1,1,2-trifluoroethane (CFC-113), dichlorodiflouromethane, dichlorotetrafluoroethane, methyl chloride, ethyl chloride and methylene chloride, etc. The amount of the organic foaming agent is no more than 5% of the total weight of the kneaded blend. Examples of the inorganic gaseous foaming agent are carbon dioxide gas, air, nitrogen gas, helium gas and argon gas, etc.

The kneaded blend may alternatively be foamed through a chemical foaming process, which uses a chemical foaming agent that undergoes a chemical reaction in the material at a high temperature to release O₂, N₂, CO or CO₂ gas and cause formation of pores. However, the dispersion of the foaming agent and the foaming operation have to be controlled carefully in a chemical foaming process. Examples of the chemical foaming agent include epsomite (Epson salt), sodium bicarbonate, ammonium bicarbonate, azodicarbonamide, p,p′-oxybisbenzene sulfonyl hydrazid (OBSH) and 5-phenyltetrazole, etc. The amount of the chemical foaming agent used is no more than 5% of the total weight of the kneaded blend.

After the shape-memory foam is made, a shape-memory test can be conducted. The shape-memory foam is heated to a temperature above the T_{g}, and then an external force is applied to form a compressive deformation “εₘ”. The external force is removed after the temperature is lowered to room temperature, and the compressive deformation changes to a value “ε_{μ}”. Then, the foam is heated again to a temperature above the T_{g} in absence of an external force, and the deformation changes to a value “εᵢᵣ”. The shape recovery ratio (Rᵣ) and the shape fixity ratio (R_{f}) of the foam are calculated by the formulae of “Rᵣ=(εₘ−εᵢᵣ)/εₘ×100%” and “R_{f}=(ε_{μ}/εₘ)×100%”.

Except the above-mentioned methods, the shape-memory foam of this invention can also be fabricated by making an intermediate material like a plate or bulk material and then subjecting the same to a second process for forming a foamed material.

The shape-memory foam of this invention may have a T_{g} of 35-80° C. and a trigger temperature of 35-70° C. The foam is rigid in room temperature, gets soft at a temperature above the T_{g} to be compressable and rollable, keeps the deformed shape when the temperature is down, and recovers its original shape in absence of an external force after being heated again to a temperature above the T_{g}.

Since the shape-memory foam of this invention can be compressed after being heated and recovers its original shape after being heated again, the shape-memory foam can be compressed to a smaller volume after being formed in a factory and heated to recover its original shape after being delivered to a user or a consumer. Therefore, the shape-memory foam is easily to use.

Moreover, because the shape-memory foam of this invention is plastic and can be changed arbitrarily in the shape at a temperature above the T_{g}, it is easy to recycle and meets the requirements of environmental protection.

Moreover, since the shape-memory foam of this invention is formed simply by kneading a low/zero-crystallinity polymeric material with a shape-memory copolyester and conducting a foaming process, it is easy to produce through a simple process.

Furthermore, since the rigidity, trigger temperature and shape recovery ratio of the shape-memory foam of this invention can be readily controlled by adjusting the crystallinity, T_{g} and percentage of the low/zero-crystallinity polymeric material, it can be widely utilized in various applications, such as heat insulation materials, humidity-adjusting membranes, composite materials, damping materials and sound insulators.

### EXAMPLES 1-5

Preparation of high-crystallinity shape-memory copolyester:

In a ratio shown in Table 1 below, terephthalic acid (TPA), bis(2-hydroxyethyl) terephthalate (BHET), Sb(OAc)₂, Co(OAc)₃ and succinic acid (SA) were loaded into a reaction tank, and then ethylene glycol (EG) was added. Nitrogen gas was introduced into the reaction tank until no air remained therein, and then the external temperature of the reaction tank was raised from room temperature to 250° C. during about 40 minutes. In the period of temperature raise in which powder dissolution occurred, ethylene glycol having a relatively lower boiling point evaporated by a portion so that ethylene glycol vapor was present in the reaction tank along with the nitrogen gas, and the pressure in the reaction tank was controlled at about 3 kg·cm⁻². The external temperature of the reaction tank was then raised to 280° C. in a heating rate of 1° C./min, while the internal temperature of the reaction tank was about 230-240°. The effluent was collected until no more effluent was generated, and then the pressure in the reaction tank was reduced to the atmospheric pressure in a rate of 0.1 kg·cm⁻²/min. After the nitrogen gas was closed, the reaction tank was drawn to vacuum to stop the esterfication reaction. The external temperature of the reaction tank was then raised from 280° C. to 290° C. to conduct a polycondensation reaction for 2 hours and obtain a product in a yield of 95%.

A differential scanning calorimeter (DSC) is utilized to determine the T_{g} and Tₘ of the copolyester of each example, and the viscosity (η), shape recovery ratio and so on of the same are also measured. The results are shown in Table 2 below. As indicated by Table 2, when more succinic acid is added, the T_{g} and Tₘ of the product are lower and the number of times of shape memory of the random copolyester is larger.

TABLE 1

| | TPA | EG | SA | BHET | Co(OAc)₂ | Sb(OAc)₃ |
|---|---|---|---|---|---|---|
| Example | (mole/g) | (mole/g) | (mole/g) | (mole/g) | (g/50 ppm) | (g/100 ppm) |
| 1 | 0.95/157.7 | 1.5/93.6 | 0.05/5.90 | 0.37/97.96 | 0.03 | 0.125 |
| 2 | 0.90/149.4 | 1.5/93.6 | 0.10/11.8 | 0.37/97.96 | 0.03 | 0.125 |
| 3 | 0.85/141.1 | 1.5/93.6 | 0.15/17.71 | 0.37/97.96 | 0.03 | 0.125 |
| 4 | 0.80/132.8 | 1.5/93.6 | 0.20/23.6 | 0.37/97.96 | 0.03 | 0.125 |
| 5 | 0.75/124.5 | 1.5/93.6 | 0.25/29.5 | 0.37/97.93 | 0.03 | 0.125 |

TABLE 2

| | | | | ^{a}Rᵣ of the | Rᵣ of the | Rᵣ of the |
|---|---|---|---|---|---|---|
| | T_{g} | Tₘ | [η] | 1^{st} time | 2^{nd} time | 3^{rd} time |
| Example | (° C.) | (° C.) | (dL/g) | (%) | (%) | (%) |
| 1 | 69.73 | 231.67 | 0.76 | 60 | 50 | 50 |
| 2 | 66.94 | 227.33 | 0.72 | 70 | 66 | 64 |
| 3 | 63.59 | 224.08 | 0.79 | 90 | 90 | 80 |
| 4 | 58.55 | 212.89 | 0.79 | 76 | 74 | 70 |
| 5 | 55.21 | 203.98 | 0.81 | 50 | 50 | — |

^{a}Rᵣ: shape recovery ratio

### Kneading of Polymers:

The shape-memory copolyester obtained was kneaded with a zero-crystallinity polymer “PET-G” (Eastar 6763™ from the Eastman Chemical Company), in a ratio of 70:30, 60:40, 50:50, 40:60 or 30:70, in a twin-screw kneader at a temperature of 220° C. (=Tₘ+10° C.) for 5 minutes, and was then rapidly cooled to 5° C. to obtain a sample SG 70, SG 60, DG50, SG 40 or SG30. The Tₘ differential enthalpy (ΔHₘ) and T_{g} of the sample were then measured with a differential scanning calorimeter, as listed in Table 3 below. As indicated by Table 3, the crystallinity of the polymer blend is lowered as the percentage of the zero-crystallinity polymer “PET-G” is increased.

TABLE 3

| | Example (Sample) | | | | |
|---|---|---|---|---|---|
| | 1 | 2 | 3 | 4 | 5 |
| | (SG70) | (SG60) | (SG50) | (SG40) | (SG30) |
| SMP | 70 | 60 | 50 | 40 | 30 |
| PET-G (Eastar 6763) | 30 | 40 | 50 | 60 | 70 |
| T_{g} (° C., by DSC) | 63.27 | 63.25 | 64.94 | 68.31 | 68.78 |
| Tₘ (° C., by DSC) | 221.08 | 219.10 | 216.27 | 211.25 | 209.98 |
| ΔHₘ (J/g) | 21.85 | 21.76 | 16.36 | 11.17 | 7.835 |

SMP: high-crystallinity shape-memory copolyester

### Production of Foam Products:

A sample SG70, SG60, SG50, SG40 or SG30 was loaded in a closed container sustaining high temperature and high pressure, and then supercritical CO₂ as a physical foaming agent was injected into the container to stay with the sample, wherein the pressure is controlled at about 2500 psi and the temperature at 155-175° C. After the sample is saturated with the foaming agent to have a homogeneous phase, the pressure is rapidly reduced to form a foamed material. The densities of the foams produced at different temperatures in each of Examples 1-5 are listed in Table 4. As indicated by Table 4, foamed materials of different densities can be obtained in this invention.

TABLE 4

| | Foaming | | | | |
|---|---|---|---|---|---|
| | temperature | Density (g/cm³) | | | |
| Example | (° C.) | Sample 1 | Sample 2 | Sample 3 | Average |
| 1 | 150 | 0.96536 | 1.08081 | — | 1.023085 |
| (SG-70) | 155 | 0.51824 | 0.7512 | — | 0.63472 |
| | 170 | 0.61867 | 0.55243 | 0.59417 | 0.588423 |
| | 175 | 1.2008 | 1.15781 | 0.98029 | 1.112967 |
| 2 | 155 | 0.73827 | 0.71437 | 0.68373 | 0.712123 |
| (SG-60) | 160 | 0.57775 | 0.55028 | 0.61121 | 0.579747 |
| 3 | 155 | 0.67533 | 0.68427 | 0.72895 | 0.696183 |
| (SG-50) | 160 | 0.53488 | 0.55192 | 0.58699 | 0.55793 |
| 4 | 155 | 0.37073 | 0.40363 | 0.37825 | 0.384203 |
| (SG-40) | 160 | 0.29668 | 0.27279 | 0.293 | 0.28749 |
| 5 | 145 | 0.38341 | 0.58809 | 0.46751 | 0.47967 |
| (SG-30) | 150 | 0.2528 | 0.24027 | 0.20687 | 0.233313 |
| | 155 | 0.19222 | 0.24506 | 0.21866 | 0.218647 |

### Shape-memory Test:

A shape-memory foam produced in any of Examples 1-5 was heated to a temperature higher than the T_{g} thereof by 5° C. and applied with an external force, and then the compressive deformation (εₘ) caused is measured. After the temperature was lowered to room temperature, the external force was removed and the resulting compressive deformation (ε_{μ}) was measured. The foam was heated to a temperature higher than the T_{g} by 5° C. in absence of an external force, and the deformation (εᵢᵣ) was measured after the shape of the foam stop changing. The shape recovery ratio (Rᵣ) and shape fixity ratio (R_{f}) were calculated based on the above-mentioned formulae, as listed in Table 5 below. As indicated by Table 5, a shape-memory foam of this invention has good shape fixity property as well as good shape-memory property.

TABLE 5

| | | Example | | | | |
|---|---|---|---|---|---|---|
| | | 1 | 2 | 3 | 4 | 5 |
| Item | | (SG70) | (SG60) | (SG50) | (SG40) | (SG30) |
| Shape fixity | after 1 | 100 | 100 | 100 | 100 | 98 |
| ratio (R_{f}) (%) | hour | | | | | |
| | after 24 | 98 | 98.7 | 96 | 97 | 94 |
| | hours | | | | | |
| Shape recovery | 1^{st} time | 71 | 53 | 60 | 99 | 94 |
| ratio (Rᵣ) (%) | 5^{th} time | 99 | 94 | 94 | 100 | 96 |
| | Average | 90 | 82.2 | 89.6 | 98.2 | 96.8 |

This invention has been disclosed above in the embodiments, but is not limited to those. It is known to persons skilled in the art that some modifications and innovations may be made without departing from the spirit and scope of this invention. Hence, the scope of this invention should be defined by the following claims.

What is claimed is:

1. A shape-memory foam, formed by kneading a shape-memory copolyester with a polymeric material in a weight ratio of 15:85 to 85:15 and then conducting a foaming process, wherein
the shape-memory copolyester has a crystallinity higher than a crystallinity of the polymeric material and is a random copolymer formed from a dicarboxylic acid mixture and a diol in excess through esterfication and polycondensation,
the dicarboxylic acid mixture comprises 30-99 mol % of an aromatic dicarboxylic acid and 70-1 mol % of a straight aliphatic dicarboxylic acid of C₄-C₁₀, and
the diol comprises a straight aliphatic diol of C₂-C₁₀.

2. The shape-memory foam of claim 1, wherein an equivalent ratio of the dicarboxylic acid mixture to the diol is about 1:1.2.

3. The shape-memory foam of claim 1, wherein the aromatic dicarboxylic acid is selected from the group consisting of terephthalic acid, naphthalene dicarboxylic acid, diphenylether dicarboxylic acid, biphenyl dicarboxylic acid, diphenylsulfone dicarboxylic acid and diphenoxyethane dicarboxylic acid.

4. The shape-memory foam of claim 1, wherein the shape-memory copolyester has a viscosity [η] of 0.3-0.8 dL/g, a glass transition temperature of 30-100° C., a melting temperature of 170-250° C. and a trigger temperature of 30-70° C.

5. The shape-memory foam of claim 1, wherein the polymeric material is selected from the group consisting of glycol-modified polyethylene terephthalate, polylactate, polycaprolactone, polyurethane, polyetherester, polyvalerolactone, polyhydroxyalkanoate, straight aliphatic copolyester and combinations thereof.

6. The shape-memory foam of claim 1, which has a trigger temperature of 35-70° C. and a glass transition temperature of 35-80° C.

7. A polymer blend for producing a shape-memory foam, comprising a shape-memory copolyester and a polymeric material in a weight ratio of 15:85 to 85:15, wherein
the shape-memory copolyester has a crystallinity higher than a crystallinity of the polymeric material and is a random copolymer formed from a dicarboxylic acid mixture and a diol in excess through esterfication and polycondensation,
the dicarboxylic acid mixture comprises 30-99 mol % of an aromatic dicarboxylic acid and 70-1 mol % of a straight aliphatic dicarboxylic acid of C₄-C₁₀, and the diol comprises a straight aliphatic diol of C₂-C₁₀.

8. The polymer blend of claim 7, wherein an equivalent ratio of the dicarboxylic acid mixture to the diol is about 1:1.2.

9. The polymer blend of claim 7, wherein the aromatic dicarboxylic acid is selected from the group consisting of terephthalic acid, naphthalene dicarboxylic acid, diphenylether dicarboxylic acid, biphenyl dicarboxylic acid, diphenylsulfone dicarboxylic acid and diphenoxyethane dicarboxylic acid.

10. The polymer blend of claim 7, wherein the shape-memory copolyester has a viscosity [η] of 0.3-0.8 dL/g, a glass transition temperature of 30-100° C., a melting temperature of 170-250° C. and a trigger temperature of 30-70° C.

11. The polymer blend of claim 7, wherein the polymeric material is selected from the group consisting of glycol-modified polyethylene terephthalate, polylactate, polycaprolactone, polyurethane, polyetherester, polyvalerolactone, polyhydroxyalkanoate, straight aliphatic copolyester and combinations thereof.

12. A method for producing a shape-memory foam, comprising kneading a shape-memory copolyester with a polymeric material in a weight ratio of 15:85 to 85:15 and then conducting a foaming process, wherein
the shape-memory copolyester has a crystallinity higher that a crystallinity of the polymeric material and is a random copolymer formed from a dicarboxylic acid mixture and a diol in excess through esterfication and polycondensation,
the dicarboxylic acid mixture comprises 30-99 mol % of an aromatic dicarboxylic acid and 70-1 mol % of a straight aliphatic dicarboxylic acid of C₄-C₁₀, and the diol comprises a straight aliphatic diol of C₂-C₁₀.

13. The method of claim 12, wherein an equivalent ratio of the dicarboxylic acid mixture to the diol is about 1:1.2.

14. The method of claim 12, wherein the aromatic dicarboxylic acid is selected from the group consisting of terephthalic acid, naphthalene dicarboxylic acid, diphenylether dicarboxylic acid, biphenyl dicarboxylic acid, diphenylsulfone dicarboxylic acid and diphenoxyethane dicarboxylic acid.

15. The method of claim 12, wherein the shape-memory copolyester has a viscosity [η] of 0.3-0.8 dL/g, a glass transition temperature of 30-100° C., a melting temperature of 170-250° C. and a trigger temperature of 30-70° C.

16. The method of claim 12, wherein the polymeric material is selected from the group consisting of glycol-modified polyethylene terephthalate, polylactate, polycaprolactone, polyurethane, polyetherester, polyvalerolactone, polyhydroxyalkanoate, straight aliphatic copolyester and combinations thereof.

17. The method of claim 12, wherein the foaming process comprises a physical foaming process or a chemical foaming process.
